(19) United States
(12) Patent Application Publication
(10) Pub. No.: US 2004/0158539 A1
(43) Pub. Date: Aug. 12, 2004

(54) Operation plan devising system, operation plan devising apparatus and computer readable record medium storing an operation plan devising program

(75) Inventors: Masayuki Akita, Gunma (JP); Hiroyuki Ishijima, Gunma (JP); Kenichi Chigira, Gunma (JP); Hiroyuki Takamatsu, Gunma (JP); Katsumi Ohyama, Tochigi (JP); Tsugio Taki, Gunma (JP); Hideki Yagisawa, Gunma (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/739,939

(22) Filed: Dec. 19, 2003

(30) Foreign Application Priority Data
Dec. 25, 2002 (JP) 2002-374723

(51) Int. Cl. G06F 17/00

(52) U.S. Cl. 705/400

(57) ABSTRACT

An operation plan devising system has a demand estimating unit estimating the demand for cash and other articles as replenishments per unit time, an inputting unit inputting the number of times of a replenishment operation or a specific replenishing operation day, and a plan making unit making an operation plan having replenishing operation days including the specific replenishing operation day and the amount/quantity of the replenishments on the replenishing operation day on the basis of the number of times of the replenishing operation and the specific replenishing operation day so that the replenishing operation is carried out the above number of times within the predetermined period of time and on a specific replenishing operation day. It is possible to readily set a plan of replenishing the cash automatic transaction apparatus with the consumables, which satisfies conditions such as a predetermined number of times of replenishment and the replenishment days.

### BACKGROUND OF THE INVENTION

(1) Field of the Invention

The present invention relates to an operation plan devising system, an operation plan devising apparatus and a computer readable record medium storing an operation plan devising program suitable for use to devise an execution plan or a dispatch operation on an automatic transaction apparatus such as an ATM (Automated Teller Machine) or the like in a store of a financial institution such as a bank or the like.

(2) Description of Related Art

Replenishment of cash in or collection of cash from an automatic cash transaction machine [hereinafter referred as an ATM (Automated Teller Machine)] installed in an automatic machine corner or an unattended automatic machine corner of a financial institution such as a bank or the like is done by a staff of a security company according to an instruction from a person in charge of the financial institution.

Concretely, a person in charge of the financial institution estimates the number of demanded bills at the ATM using a method disclosed in, for example, patent document 1, refers to the estimated number of demanded bills, estimates the time when the ATM runs out of funds on the basis of his/her experiences, perception or the like, and makes a funds replenishment instruction document so that the funds are replenished immediately before the funds run out.

The person in charge transmits the funds replenishment instruction document made as above to a cash raising division to request it to raise necessary cash, and transmits it to a security company as well to request it to deliver (replenish) the cash to the ATM or collect surplus funds from the ATM.

The cash raising division deposits an instructed amount of funds in an account for funds loading at the instructed time according to the cash replenishment instruction document. The security company withdraws the instructed amount of cash from the account for loading at the instructed time, and delivers (fills) it to the ATM or collect the instruction amount of surplus funds from the ATM according to the cash replenishment instruction document.

The operator of the security company reports the financial institution of information on funds actually replenished or collected (kinds of money, the number of bills, the number of coins, etc.). The person in charge of the financial institution can thereby know an actual amount of stored cash in the ATM, and reflects the information on the amount of stored cash when estimating the demand for cash at the ATM.

Generally, the financial institution makes a contract with the security company that the security company periodically dispatches the stuff. This periodical dispatch contract is that the security company dispatches the stuff a predetermined number of times (for example, five times) within a predetermined period of time (for example, one month) at a fixed charge (for example, 20,000 yen). When the financial institution makes the dispatch request more often than the predetermined number of times, the financial institution has to pay a higher charge for an extra dispatch charge (for example, 6,000 yen for every dispatch).

[Patent Document]

Japanese Patent Laid-Open Publication No. 9-27002 (page 11, FIG. 15)

According to the above operation plan devising method, the person in charge of the financial institution refers to an estimated demand for funds * at each ATM, and makes a funds replenishment instruction document on the basis of his/her experiences, perception, or the like. Accordingly, it is difficult for a person in charge having a little experience to make an optimum funds replenishment plan. It is also difficult to change a funds replenishment plan once made according to convenience of the person in charge.

When the financial institution makes a periodical dispatch contract as above with the security company, it is more convenient for the financial institution that the security company dispatches the operator a predetermined number of times defined in the contract because the financial company can request the operator to do operations such as replenishment of consumables (for example, receipt forms, journal forms, etc.), resolution of a fault and the like other than funds replenishment at the same time when the operator is dispatched. Additionally, estimation of the demand for funds at the ATM is made on the basis of an actual amount of stored cash in the ATM reported from the operator of the security company, the larger the number of times of dispatch of the operator by the security company, the more the accuracy of estimation on the demand for funds can be improved. Accordingly, there is a demand to readily make a funds replenishment plan that the security company dispatches the operator an arbitrary number of times (a predetermined number of times defined in the contract).

There is another demand to readily make a replenishment plan that the cash automatic transaction apparatus is replenished with consumables on a predetermined replenishment day.

When a plurality of ATMs are installed in one unattended store or the like, the security company dispatches the operator thereto each time replenishment in the ATM becomes necessary. For this, it is frequent that the financial institution requests the security company to dispatch (deliver) the operator a larger number of times than the predetermined number of times defined in the contract, which causes an increase in charge to be paid to the security company and in operation cost.

### SUMMARY OF THE INVENTION

In the light of the above problems, an object of the present invention is to provide an operation plan devising system, an operation plan devising apparatus and a computer readable record medium storing an operation plan devising program, whereby the operator can readily set a plan of replenishing a cash automatic transaction apparatus with consumables, which can satisfy conditions such as a predetermined number of times of dispatch, replenishment days, etc., and readily adjust replenishment days on which a plurality of cash automatic transaction apparatuses are replenished with consumables, thereby decreasing the operation cost and improving the business efficiency.

[Means for Solving the Problems]

The present invention therefore provides an operation plan devising system devising a plan for at least one time of replenishing operation that at least one operator replenishes cash and other articles in a cash automatic transaction apparatus which accommodates a predetermined amount/quantity of said cash and other articles and needs to be replenished with the cash and other articles, the operation plan devising system comprising a demand estimating unit estimating a demand for the cash and other articles per unit time as replenishments in the cash automatic transaction apparatus, an inputting unit inputting the number of times of the replenishment operation or a specific replenishing operation day within a predetermined period of time on the cash automatic transaction apparatus, and a plan making unit making an operation plan having replenishing operation days including the specific replenishing operation day and an amount/quantity of the replenishments to be replenished on the replenishing operation days on the basis of a result of demand estimation made by the demand estimating unit and the number of times of the replenishing operation or the specific replenishing operation day inputted through the inputting unit so that the replenishing operation is carried out the number of times within the predetermined period of time.

The operation plan devising system may further comprise a changing unit being able to change the operation plan made by the plan making unit, and when the operation plan is changed by the changing unit, the plan making unit may re-determine at least either the replenishing operation days or the amount/quantity of the replenishments on the basis of the operation plan after changed.

The operation plan devising system may still further comprise a displaying unit being able to display the operation plan made by the plan making unit, and the changing unit may change the operation plan on the basis of information inputted in a changing screen through which the operation plan displayed on the displaying unit can be changed.

The operation plan devising system may still further comprise a display control unit controlling the displaying unit so that the operation plan after changed is displayed in a color differing from a color in which the operation plan before changed is displayed when the operation plan is changed by the changing unit.

The operation plan devising system may still further comprise an evaluating unit evaluating realizability of the operation plan on the cash automatic transaction apparatus determined by the plan making unit, and a warning unit generating a warning when the evaluating unit determines as a result of evaluation that the realizability of the operation plan is small.

The present invention further provides an operation plan devising system devising a plan for at least one time of replenishing operation that at least one operator replenishes cash and other articles in a plurality of cash automatic transaction apparatuses each of which accommodates a predetermined amount/quantity of the cash and other articles and needs to be replenished with the cash and other articles, the operation plan devising system comprising a replenishment day estimating unit being able to estimate replenishment required days on which the cash and other articles are to be replenished as replenishments in each of the plural cash automatic transaction apparatuses as an operation plan, and a plan compensating unit regarding replenishment days of a cash automatic transaction apparatus which needs to be replenished most frequently among the plural cash automatic transaction apparatuses as reference replenishment days on the basis of the replenishment required days of the plural cash automatic transaction apparatuses estimated by the replenishment day estimating unit, and adjusting replenishment days of other cash automatic transaction apparatuses to the reference replenishment days to compensate the operation plan.

The present invention still further provides an operation plan devising system devising a plan for at least one time of replenishing operation that at least one operator replenishes cash and other articles in a plurality of cash automatic transaction apparatuses each of which accommodates a predetermined amount/quantity of the cash and other articles and needs to be replenished with the cash and other articles, the operation plan devising system comprising a replenishment day estimating unit estimating the next replenishment required day on which the cash and other articles are to be replenished as replenishments in each of the plural cash automatic transaction apparatuses on the basis of a basic replenishment day as a reference, and a plan making unit setting a cash automatic transaction apparatus which needs to be replenished earliest among the plural cash automatic transaction apparatuses as a reference cash automatic transaction apparatus on the basis of the next replenishment required days of the plural cash automatic transaction apparatuses estimated by the replenishment day estimating unit, setting a replenishment day of the reference cash automatic transaction apparatus as the basic replenishment day, and when the cash automatic transaction apparatus whose next replenishment required day is the earliest among the plural cash automatic transaction apparatuses is the reference cash automatic transaction apparatus, adjusting replenishment days of other cash automatic transaction apparatuses to the basic replenishment day to make an operation plan.

The present invention still further provides an operation plan devising apparatus devising a plan for at least one time of replenishing operation that at least one operator replenishes cash and other articles in a cash automatic transaction apparatus which accommodates a predetermined amount/quantity of the cash and other articles and needs to be replenished with the cash and other articles, the operation plan devising apparatus comprising an inputting unit inputting the number of times of the replenishing operation or a specific replenishing operation day within a predetermined period of time on the cash automatic transaction apparatus, and a plan making unit determining an operation plan having replenishing operation days including the specific replenishing operation day and an amount/quantity of the replenishments on the replenishing operation day on the basis of a result of demand estimation for the cash and other articles as replenishments per unit time in the cash automatic transaction apparatus and the number of times of the replenishing operation or the specific replenishing operation day inputted through the inputting unit so that the replenishing operation is carried out the number of times within the predetermined period of time and on a specific replenishing operation day.

The operation plan devising apparatus may further comprise a changing unit being able to change the operation plan made by the plan making unit, and when the operation plan is changed by the changing unit, the plan making unit may re-determine at least either the replenishing operation days or the amount/quantity of the replenishments on the basis of the operation plan after changed.

The operation plan devising apparatus may still further comprise a displaying unit being able to display the operation plan made by the plan making unit, the changing unit may change the operation plan on the basis of information inputted in a changing screen through which the operation plan displayed on the displaying unit can be changed.

The operation plan devising apparatus may still further comprise a display control unit controlling the displaying unit so that the operation plan after changed is displayed in a color differing from a color in which the operation plan before changed is displayed when the operation plan is changed by the changing unit.

The operation plan devising apparatus may still further comprise an evaluating unit evaluating realizability of the operation plan on the cash automatic transaction apparatus determined by the plan making unit, and a warning unit generating a warning when the evaluating unit determines as a result of evaluation that the realizability of the operation plan is small.

The present invention still further provides an operation plan devising apparatus devising a plan for at least one time of replenishing operation that at least one operator replenishes cash and other articles in a plurality of cash automatic transaction apparatuses each of which accommodates a predetermined amount/quantity of the cash and other articles and needs to be replenished with the cash and other articles, the operation plan devising apparatus comprising a replenishment day estimating unit being able to estimate replenishment required days on which the cash and other articles are to be replenished as replenishments in each of the plural cash automatic transaction apparatuses as an operation plan, and a plan compensating unit regarding replenishment days of a cash automatic transaction apparatus which needs to be replenished most frequently among the plural cash automatic transaction apparatuses as reference replenishment days on the basis of the replenishment required days of the plural cash automatic transaction apparatuses estimated by the replenishment day estimating unit, and adjusting replenishment days of other cash automatic transaction apparatuses to the reference replenishment days to compensate the operation plan.

The present invention still further provides an operation plan devising apparatus devising a plan for at least one time of replenishing operation that at least one operator replenishes cash and other articles in a plurality of cash automatic transaction apparatuses each of which accommodates a predetermined amount/quantity of the cash and other articles and needs to be replenished with the cash and other articles, the operation plan devising apparatus comprising a replenishment day estimating unit estimating the next replenishment required day on which the cash and other articles are to be replenished as replenishments in each of the plural cash automatic transaction apparatuses on the basis of a basic replenishment day as a reference, and a plan making unit setting a cash automatic transaction apparatus which needs to be replenished earliest among the plural cash automatic transaction apparatuses as a reference cash automatic transaction apparatus on the basis of the next replenishment required days of the plural cash automatic transaction apparatuses estimated by the replenishment day estimating unit, setting a replenishment day of the reference cash automatic transaction apparatus as the basic replenishment day, and when the cash automatic transaction apparatus whose next replenishment required day is the earliest among the plural cash automatic transaction apparatuses is the reference cash automatic transaction apparatus, adjusting replenishment days of other cash automatic transaction apparatuses to the basic replenishment day to make an operation plan.

The present invention still further provides a computer readable record medium holding an operation plan devising program for making a computer execute an operation plan devising function of devising a plan for at least one time of replenishing operation that at least one operator replenishes cash and other articles in a cash automatic transaction apparatus which accommodates a predetermined amount/quantity of the cash and other articles and needs to be replenished with the cash and other articles, the operation plan devising program making the computer function as an inputting unit inputting the number of times of the replenishing operation or a specific replenishing operation day within a predetermined period of time on the cash automatic transaction apparatus, and a plan making unit determining an operation plan having replenishing operation days including the specific replenishing operation day and an amount/quantity of the replenishments on the replenishing operation day on the basis of a result of demand estimation for the cash and other articles as replenishments per unit time in the cash automatic transaction apparatus and the number of times of the replenishing operation or the specific replenishing operation day inputted through the inputting unit so that the replenishing operation is carried out the number of times within the predetermined period of time and on a specific replenishing operation day.

The operation plan devising program may make the computer function as a changing unit being able to change the operation plan made by the plan making unit, and when the operation plan is changed by the changing unit, the plan making unit may re-determine at least either the replenishing operation days or the amount/quantity of the replenishments on the basis of the operation plan after changed.

The operation plan devising program may further make the computer function as a display control unit being able to control the displaying unit so that the displaying unit displays the operation plan made by the plan making unit, the changing unit may change the operation plan on the basis of information inputted in a changing screen through which the operation plan displayed on the displaying unit can be changed.

The operation plan devising program may make the computer function in a way that the display control unit controls the displaying unit so that the operation plan after changed is displayed in a color differing from a color in which the operation plan before changed is displayed when the operation plan is changed by the changing unit.

The operation plan devising program may make the computer function as an evaluating unit evaluating realizability of the operation plan on the cash automatic transaction apparatus determined by the plan making unit, and a warning unit generating a warning when the evaluating unit determines as a result of evaluation that the realizability of the operation plan is small.

The present invention still further provides a computer readable record medium holding an operation plan devising program for making a computer execute an operation plan devising function of devising a plan for at least one time of replenishing operation that at least one operator replenishes cash and other articles in a plurality of cash automatic transaction apparatuses each of which accommodates a predetermined amount/quantity of the cash and other articles and needs to be replenished with the cash and other articles, the operation plan devising program making the computer function as a replenishment day estimating unit being able to estimate replenishment required days on which the cash and other articles need to be replenished as replenishments in each of the plural cash automatic transaction apparatuses as an operation plan, and a plan compensating unit regarding replenishment days of a cash automatic transaction apparatus which needs to be replenished most frequently among the plural cash automatic transaction apparatuses as reference replenishment days on the basis of the replenishment required days of the plural cash automatic transaction apparatuses estimated by the replenishment day estimating unit, and adjusting replenishment days of other cash automatic transaction apparatuses to the reference replenishment days to compensate said operation plan.

The present invention still further provides a computer readable record medium holding an operation plan devising program for making a computer execute an operation plan devising function of devising a plan for at least one time of replenishing operation that at least one operator replenishes cash and other articles in a plurality of cash automatic transaction apparatuses each of which accommodates a predetermined amount/quantity of the cash and other articles and needs to be replenished with the cash and other articles, the operation plan devising program making the computer function as a replenishment day estimating unit estimating the next replenishment required day on which the cash and other articles are to be replenished as replenishments in each of the plural cash automatic transaction apparatuses on the basis of a basic replenishment day as a reference, and a plan making unit setting a cash automatic transaction apparatus which needs to be replenished earliest among the plural cash automatic transaction apparatuses as a reference cash automatic transaction apparatus on the basis of the next replenishment required days of the plural cash automatic transaction apparatuses estimated by the replenishment day estimating unit, setting a replenishment day of the reference cash automatic transaction apparatus as the basic replenishment day, and when the cash automatic transaction apparatus whose next replenishment required day is the earliest among the plural cash automatic transaction apparatuses is the reference cash automatic transaction apparatus, adjusting replenishment days of other cash automatic transaction apparatuses to the basic replenishment day to make an operation plan.

[Effect of the Invention]

The operation plan devising system, the operation plan devising apparatus and a computer readable record medium storing an operation plan devising program according to this invention provide the following effects and advantages.

(1) An operation plan containing replenishing operation days including a specific replenishing operation day and the amount/quantity of replenishments is determined on the basis of a result of demand estimation made by the demand estimating unit, and the number of times of the replenishing operation or the specific replenishing operation day inputted through the inputting unit so that the replenishing operation is carried out the above number of times within a predetermined period of time. Accordingly, the financial institution has the operator carry out the replenishing operation on the cash automatic transaction apparatus an arbitrary number of times, and carry out supplementary operations other than the replenishing operation at the same time, which is convenient for the financial institution. The financial institution can obtain more information on an actual amount of stored bills in the cash automatic transaction apparatus to improve the accuracy of estimation of the demand for funds at the cash automatic transaction apparatus. Additionally, the financial institution can arbitrarily set the replenishing operation, which is convenient to the financial institution.

(2) When the operation plan is changed by the changing unit, the plan making unit re-determines at least either the replenishing operation days or the amount/quantity of the replenishments on the basis of the operation plan after changed. It is thereby possible to readily change the operation plan, which is convenient.

(3) The changing unit changes the operation plan on the basis of information inputted in the changing screen through which the operation plan displayed on the displaying unit can be changed. This is convenient for the operator because the operator can easily change the operation plan.

(4) When the operation plan is changed by the changing unit, the display control unit controls the displaying unit so that the operation plan after changed is displayed in a color differing from a color in which the operation plan before changed is displayed. This improves the visibility to the operator, which is convenient.

(5) The evaluating unit evaluates the realizability of the operation plan determined by the plan making unit on the cash automatic transaction apparatus, and the warning unit generates a warning when the evaluating unit determines that the realizability of the operation plan is small. The operator can thereby know easily and quickly that the replenishing operation having a low realizability is set, which improves the reliability of the operation plan.

(6) It is possible to readily adjust replenishment days of a plurality of cash automatic transaction apparatuses. Accordingly, the cost to be paid for the replenishing operation by the operator can be reduced, which enables a decrease in the operation cost.

### BRIEF DESCRIPTION OF THE DRAWINGS

FIG. 1 is a block diagram showing a structure of an operation plan devising system according to a first embodiment of this invention;

FIG. 2 is a diagram schematically showing a practical structure of an operation plan devising unit of the operation plan devising system according to the first embodiment of this invention;

FIG. 3 is a diagram showing an example of an input screen for inputting operation conditions in the operation plan devising system according to the first embodiment of this invention;

FIG. 4 is a diagram showing an example of demand estimation made by a demand estimating unit of the operation plan devising system according to the first embodiment of this invention;

FIG. 5 is a diagram showing an example of display of an operation plan in the operation plan devising system according to the first embodiment of this invention;

FIGS. 6 and 7 are diagrams for illustrating a method of changing the operation plan in the operation plan devising system according to the first embodiment of this invention;

FIG. 8 is flowchart for illustrating a replenishment plan making method in the operation plan devising system according to the first embodiment of this invention;

FIG. 9 is a flowchart for illustrating another replenishment plan making method in the operation plan devising system according to the first embodiment of this invention;

FIGS. 10 through 12 are diagrams showing an example of an operation plan made by the operation plan devising system according to the first embodiment of this invention;

FIG. 13 is a block diagram showing a structure of an operation plan devising system according to second and third embodiments of this invention;

FIG. 14 is a flowchart for illustrating a replenishment plan making method in the operation plan devising system according to the second embodiment of this invention;

FIGS. 15 through 18 are diagrams showing an example of an operation plan made by the operation plan devising system according to the second embodiment of this invention;

FIG. 19 is a flowchart for illustrating a replenishment plan making method in the operation plan devising system according to the third embodiment of this invention; and

FIGS. 20 through 23 are diagrams showing an example of an operation plan made by the operation plan devising system according to the third embodiment of this invention.

### DESCRIPTION OF THE PREFERRED EMBODIMENTS

Hereinafter, description will be made of embodiments of the present invention with reference to the drawings.

### (A) Description of First Embodiment

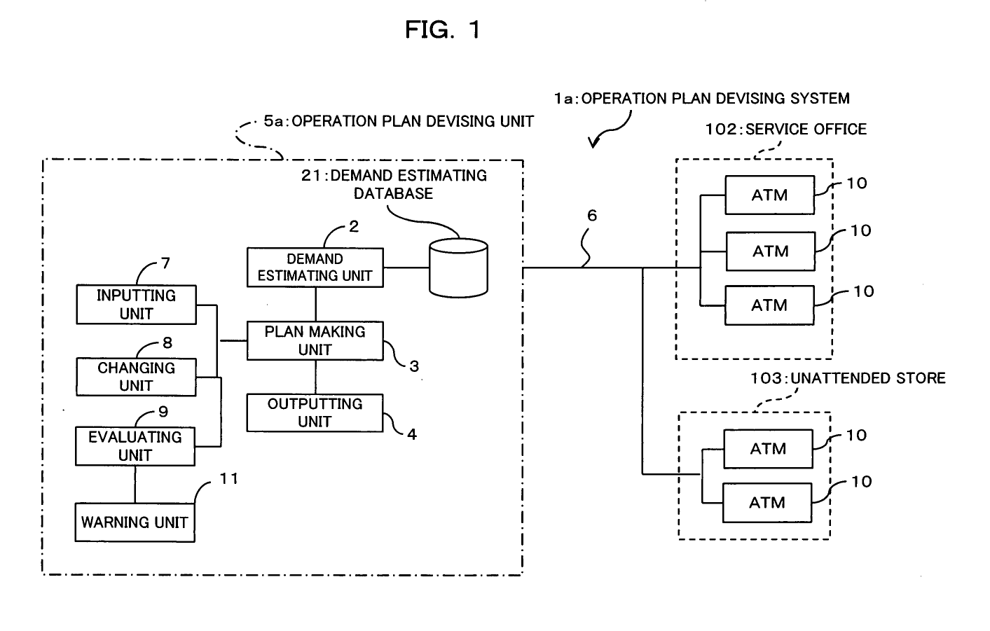

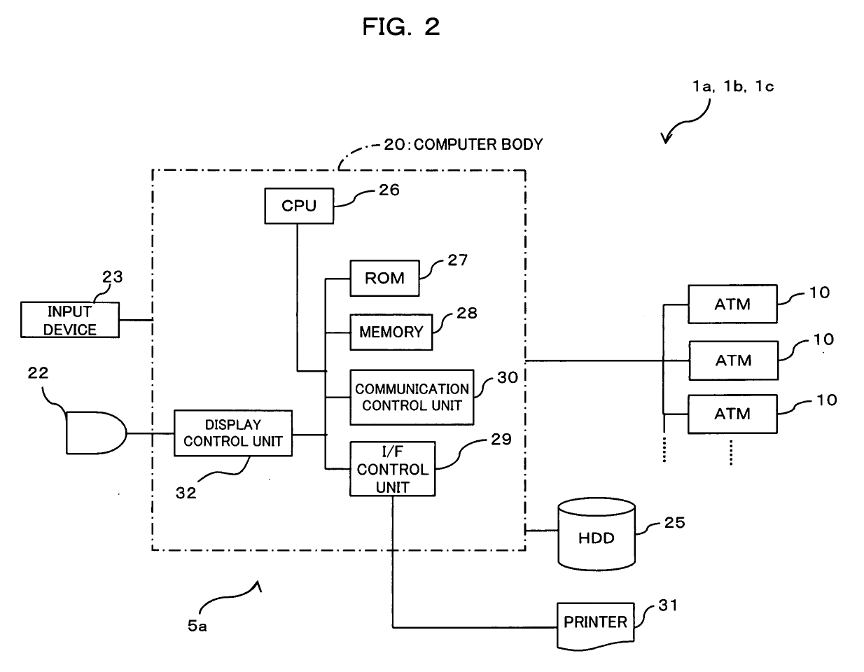

FIG. 1 is a block diagram showing a structure of an operation plan devising system according to a first embodiment of this invention. FIG. 2 is a diagram schematically showing a practical structure of an operation plan devising unit 5a of the operation plan devising system.

The operation plan devising system la according to this embodiment devises a plan for one or more times of replenishing operation that an operator replenishes cash and/or other articles in an ATM (Automated Teller Machine; cash automatic teller machine, cash automatic transaction apparatus) which accommodates cash and other articles and needs to be replenished with cash and other articles. The operation plan devising system 1a is provided to a financial institution such as a bank, a credit loan company or the like. The operation plan devising system 1a is operated by a person in charge (operator) of, for example, a financial institution to output (present) an operation plan (a replenishing operation instruction document) to the operator.

The operation plan devising system 1a is configured by communicably connecting at least one ATM 10 and the operation plan devising unit 5a to each other over a communication line 6, as shown in FIG. 1.

The ATM 10 is a cash automatic transaction apparatus installed in a service office (store) 102, an unattended store 103 or the like by a financial institution such as a bank, a credit loan company or the like. The ATM 10 can accommodate a required amount/quantity of cash and other articles, and carries out various processes such as withdrawals, deposits or anything according to operations (transactions) by users (customers). In the operation plan devising system 1a according to the first embodiment, a plurality of ATMs 10 are installed in the service office 102 or the unattended store 103.

Cash (bills, coins) to be loaded in the ATM 10 is consumables consumed by making transactions at the ATM 10, and also is a replenishment to be replenished by the financial institution or the like at need. Incidentally, cash loaded in the ATM 10, and not used by customers but still remains inside the ATM 10 is called surplus funds. It is desirable to suppress such surplus funds as much as possible.

The ATM 10 accommodates receipt forms, journal forms, transfer tickets, receipt/payment slips, passbooks to be issued and the like. The ATM 10 prints contents of various transactions made with customers, and outputs or retains them. The receipt forms, the journal forms, the transfer tickets, the receipt/payment slips and passbooks to be issued are consumables consumed by making transactions at the ATM 10, and are replenished (replenishments) by an operator of the financial institution or a security company at need. Namely, the receipt forms, the journal forms, the transfer tickets, the receipt/payment slips, the passbooks to be issued and the like can be handled like cash and other articles, required quantities of which are accommodated in the ATM 10.

Hereinafter, description will be made by way of example where bills are used as cash or other articles to be accommodated in the ATM 10.

The ATM 10 transmits information on transactions to the operation plan devising unit 5a.

The operation plan devising unit 5a comprises, as shown in FIG. 1, a demand estimating unit 2, a demand estimation database 21, a plan making unit 3, an outputting unit 4, an inputting unit 7, a changing unit 8, an evaluating unit 9 and a warning unit 11. As shown in FIG. 2, the operation plan devising unit 5a is realized with a computer communicably connected to the ATM 10. As the computer, it is possible to use any one of various computers such as a work station, a personal computer, a host computer and the like, for example.

In this embodiment, a computer is a concept including hardware and an operating system, signifying hardware operating under a control of the operating system. When the operating system is unnecessary and an application program solely operates the hardware, the hardware itself corresponds to the computer. The hardware comprises, at least, a microprocessor such as a CPU or the like, and a means for reading a computer program stored in a record medium. According to this embodiment, the computer functions as the above operation plan devising unit 5a or an operation plan devising unit 5b/5c to be described later.

The operation plan devising unit 5a comprises, as shown in FIG. 2, a computer body 20, along with a display 22, an input device 23, a hard disk drive (HDD) 25 and a printer 31 which are connected to the computer body 20.

The computer body 20 comprises a CPU 26 carrying out internal various controls and processes, a ROM (Read Only Memory) 27 (a non-volatile storage) for storing programs and various data, a memory 28, an interface control unit (referred as an I/F control unit) 29, a display control unit 32 controlling displays to the display 22, a communication control unit 30, etc.

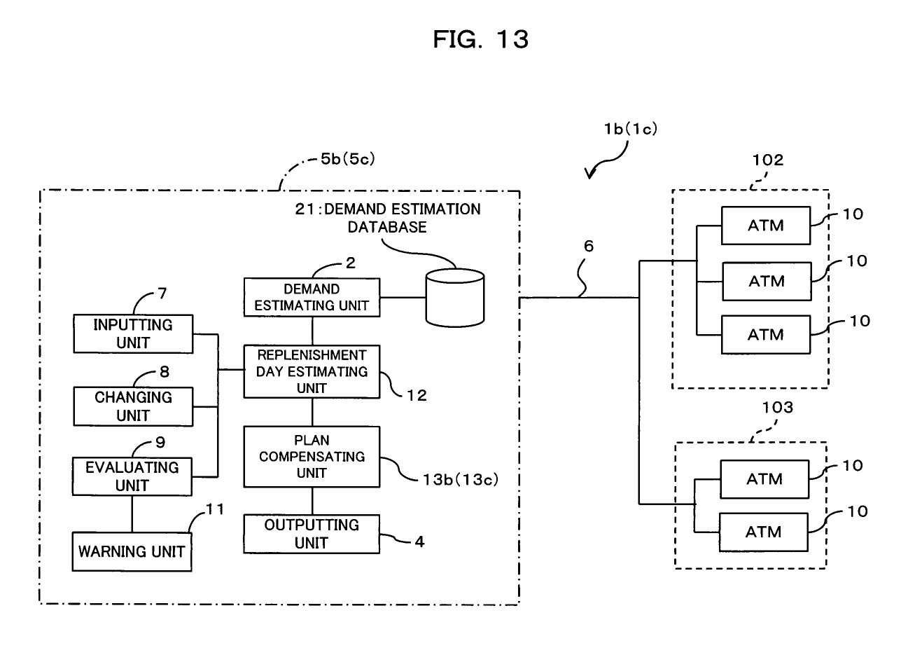

An operation plan devising program according to this invention is stored in, for example, a magnetic disk (a record medium) of the HDD 25, and the CPU 26 reads out the program and executes it to function as the demand estimating unit 2, the demand estimation database 21, the plan making unit 3, the outputting unit 4, the inputting unit 7, the changing unit 8, the evaluating unit 9, the warning unit 11, a plan compensating unit 13a/13b (refer to FIG. 13, details of which will be described later), and a replenishment day estimating unit 12 (refer to FIG. 13, details of which will be described later). Whereby, the operation plan devising unit 5a (the operation plan devising system 1a) is realized.

Note that the present invention is not limited to the above example. The program may be stored in the magnetic disk of the HDD 25 in other manner, for example, and the CPU 26 may execute the program to carry out the above processes.

For example, a program (program data made by another apparatus) stored in a removable disk (for example, a flexible disk, an optical disk or the like) made by another apparatus (not shown) may be read out by a removable disk drive (for example, a flexible disk drive, an optical disk drive or the like) not shown, and stored in the record medium of the HDD 25. Alternatively, data such as a program transmitted from another apparatus over a communication line (not shown) such as LAN (Local Area Network) or the like may be received through the communication control unit 30, and stored in the record medium (magnetic disk) of the HDD 25.

The input device 23 can be used by an operator to input various sorts of information, which is configured with a keyboard, a mouse and/or the like.

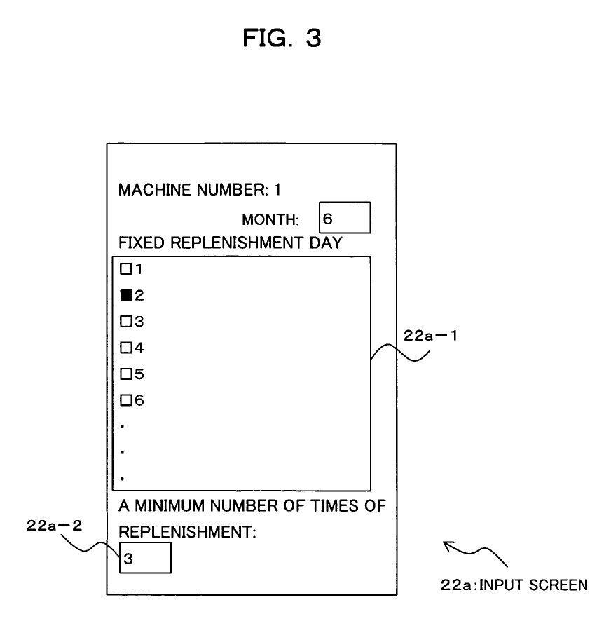

The display 22 displays various sorts of information so that the user can peruse the information. The display 22 displays an input screen 22a (refer to FIG. 3) or an operation plan made by the CPU 26 (the plan making unit 3 ). Namely, the display 22 can present an operation plan (a replenishing operation instruction document) to the operator.

The printer 31 prints out various sorts of information so that the user can peruse the information. The printer 31 can print out at an operation plan made by the CPU 26 (the plan making unit 3) on a medium such as paper or the like to present the operation plan (the replenishing operation instruction document) to the operator.

The input unit 7 of the operation plan devising system 1a is used by a person in charge or the like of the financial institution to input conditions (operation conditions) for making an operation plan, that is, the number of times of the replenishing operation and a specific replenishing operation day on the ATM 10 within a predetermined period of time. Hereinafter, the number of times of the replenishing operation and the specific replenishing operation day are referred as operation conditions, occasionally. The input unit 7 is realized with the input device 23 described above.

In the operation plan devising system 1a according to the first embodiment, the operator inputs the number of times of the replenishing operation [a minimum number of times of replenishment (n): n being a natural number] and a day (a fixed replenishment day) on which the replenishing operation is carried out without fail (at least) as operation conditions from the input device 23.

When the financial institution makes a periodical dispatch contract with the security company that the security company dispatches a stuff a predetermined number of times within a predetermined period of time (for example, one month) at a fixed charge, it is desirable that the operator inputs the predetermined number of times defined in the contract.

FIG. 3 is a diagram showing an example of the input screen for inputting the operation conditions in the operation plan devising system 1a according to the first embodiment of this invention. The input screen 22a shown in FIG. 3 is displayed on the display 22 under a control of the display control unit 32. The input screen 22a has a fixed replenishment day input area 22a-1 where a fixed replenishment day can be selected (inputted), and a minimum replenishment frequency input area 22a-2 into which a minimum number of times of replenishment (n) can be inputted.

The operator uses the input device 23 to select a fixed replenishment day in the fixed replenishment day input area 22a-1 of the input screen 22a, or input a minimum number of times of replenishment (n) in the minimum replenishment frequency input area 22a-2 at need.

The demand estimating unit 2 estimates the demand for cash (replenishment) at the ATM 10. The demand estimating unit 2 has the demand estimation database 21 as shown in FIG. 1, and calculates and estimates the number of demanded bills within an estimation period of time on the basis of past transaction data at each ATM 10 accumulated in the demand estimation database 21.

Various transaction data at each ATM 10 is written in the demand estimation database 21, which is formed on a storage such as a hard disk, a memory, or the like of the computer system. As the transaction data, \mathring{1} to \mathring{6} below, for example, are periodically drawn from a control unit (not shown) of each ATM 10 over the communication line 6, and stored in the demand estimation database 21.

\mathring{1} machine specifying data: bank number, branch number, machine number;

\mathring{2} transaction date/time: year/month/day, transaction start time, transaction end time;

\mathring{3} transaction type: withdrawal, deposit, transfer, balance inquiry;

\mathring{4} the number of withdrawn bills: 10,000-yen bills, 5,000-yen bills, 1,000-yen bills, various coins;

\mathring{5} the number of deposited bills: 10,000-yen bills, 5,000-yen bills, 1,000-yen bills, various coins;

\mathring{6} the amount of stored bills in machine: 10,000-yen bills, 5,000-yen bills, 1,000-yen bills, various coins;

The demand estimating unit 2 calculates and estimates the demand for cash (replenishment) within a designated period of time at the ATM 10 on the basis of past transaction data in the ATM 10, as disclosed in, for example, Japanese Patent Laid-Open Publication No. 9-27002. The demand estimating unit 2 has a function of writing transaction data in a predetermined area of the demand estimation database 21 when the transaction data is collected from each ATM 10, and a function of calculating and estimating the number of demanded bills within an estimation period of time on the basis of past transaction data at each ATM 10 accumulated in the demand estimation database 21 when the estimation period of time is designated by a person in charge in a screen inputting process. In the operation plan devising system 1a, the demand estimating unit 1a estimates the demand for bills to be consumed by customers, using an estimation system called Hayashi's quantification theory.

The demand estimating unit 2 collects the amount of receipts and payments and the amount of stored bills per unit time in the ATM 10, stores them in the demand estimation database 21, and estimates the demand for cash (replenishment) at the ATM 10 on the basis of information stored in the demand estimation database 21.

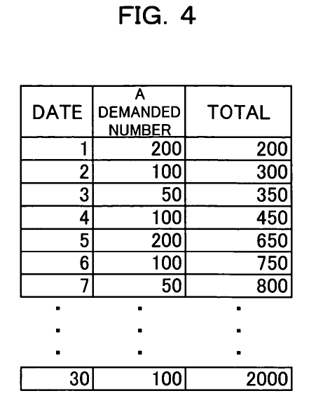

FIG. 4 is a diagram showing an example of demand estimation made by the demand estimating unit 2 in the operation plan devising system 1a according to the first embodiment of this invention. The example in FIG. 4 shows the number of demanded bills (Ai) and a total number of demanded bills of each day in a certain month.

The demand estimating unit 2 can estimate the number of demanded bills (Ai) at the ATM 10 per unit time (per day in this embodiment), showing the number of demanded bills (Ai) and a total number of demanded bills in a relevant unit time (day). The demand estimating unit 2 calculates a total (T) of the number of demanded bills within a specific period of time (one month in the example shown in FIG. 4).

The total (T) can be derived from the following equation (1), where m stands for a specific period of time, which is the number of days in one month (m=30 in the example shown in FIG. 4) in this embodiment.

[Equation 1]

$$T = {\sum }_{i = 1}^{m} A i \qquad ( 1 )$$

The demand estimating unit 2 can calculate and estimate the number of demanded bills within a designated period of time at the ATM 10 on the basis of past transaction data accumulated in the demand estimation database 21, and manage the number of demanded bills at the ATM 10 on the basis of the estimated value. Accordingly, it is possible to certainly compress the amount of funds to be loaded, and largely decrease the load on the person in charge. The demand estimating unit 2 expresses quality factors such as day of the week, date, etc. as degrees of effect, thereby estimating the number of demanded bills at a cash automatic transaction apparatus in consideration of various quality factors. This enables high-accurate estimation.

When a plurality of ATMs 10 are installed in the same place or places in proximity to each other such as service offices 102, unattended stores 103, or the like, the demand estimating unit 2 may regard the plural ATMs 10 as one ATM 10 (group management), and estimate a total number of demanded bills (a total amount of demanded cash).

The plan making unit 3 determines an operation plan containing replenishing operation days including a specific replenishing operation day and the quantity/amount of replenishments to be replenished on a relevant replenishing operation day on the basis of a result of demand estimation made by the demand estimating unit 2 and operation conditions (the number of times of the replenishing operation or the specific replenishing operation day) inputted through the inputting unit 7 so that the replenishing operation is carried out a designated number of times within a predetermined period of time.

In concrete, on the basis of a fixed replenishment day selected (inputted) in the fixed replenishment day input area 22a-1 and a minimum number of times of replenishment (n; n being a natural number) inputted in the minimum replenishment frequency input area 22a-2 on the input screen 22 a display on the display 22, the plan making unit 3 determines an operation plan containing replenishing operation days including a specific replenishing operation day (the 2nd in the example shown in FIG. 3) and a quantity/amount of replenishments to be replenished on a relevant replenishing operation day so that the replenishing operation is carried out a designated number of times (three times in the example shown in FIG. 3) within a predetermined period of time (one month in this embodiment).

According to the first embodiment, the number of bills to be replenished (the amount of replenishment) in one time of replenishing operation is T/n, which is determined by dividing a total (T) of demanded bills within a specific period of time given by the above equation (1) by a minimum number of times of replenishment (n).

The outputting unit 4 outputs an operation plan (a replenishing operation instruction document) made by the plan making unit 3 to present it to a person in charge or the like of the financial institution.

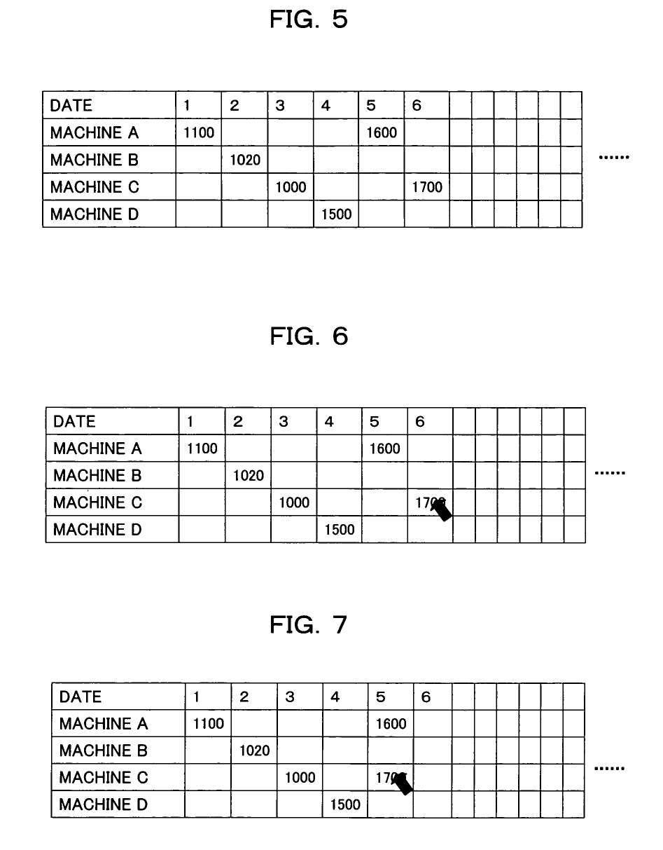

FIG. 5 is a diagram showing an example of display of the operation plan made in the operation plan devising system 1a according to the first embodiment of this invention, showing an example of the operation plan displayed on the display 22. The example in FIG. 5 shows operation plans made with respect to a plurality of ATMs 10 (machine A, machine B, machine C and machine D) as a list.

The changing unit 8 can change the operation plan made by the operation plan making unit 3. By means of the changing unit 8, the operator can change an operation plan (for example, a specific replenishing operation day or the number of bills) outputted from the outputting unit 4 at need.

FIGS. 6 and 7 are diagrams for illustrating an operation plan changing method in the operation plan devising system 1a according to the first embodiment of this invention. For example, the operator selects (clicks), with a mouse, a replenishing operation set to a specific day on a specific ATM 10 in an operation plan displayed on the display shown in FIG. 5 (refer to FIG. 6), moves (drags and drops) the replenishing operation to a day on which the operator desires the replenishing operation (refer to FIG. 7) to change the operation plan.

By changing (moving) the specific replenishing operation as above, it is determined that a replenishing operation day after changed is set as the specific replenishing operation day. Namely, the changing unit 8 changes the operation plan on the basis of information inputted through a changing screen as shown in FIGS. 6 and 7 displayed on the display 22.

The plan making unit 3 re-calculates the operation plan after changed, and makes an operation plan to which the change has been reflected. In other words, when the operation plan is changed by means of the changing unit 8, the plan making unit 3 determines again at least either the replenishing operation day or the number of bills on the basis of the changed operation plan (the specific replenishing operation day or the number of bills).

When the operation plan displayed on the display 22 is changed by a drag-and-drop with a mouse or the like as above, the replenishing operation before moved and the replenishing operation after moved are displayed, for example, in different colors on the display 22 or the like. This improves the visual perception of the operator, and is convenient for the operator. When the operation plan is displayed in black characters on the display 22, for example, the replenishing operation before changed (moved) is displayed in blue characters, while the replenishing operation after changed (moved) is displayed in red characters. Whereby, the operator can readily recognize a change in the operation plan.

The person in charge of the financial institution compensates the replenishing operation instruction document outputted from the outputting unit 4 at need, then transmits it to a cash raising division (not shown) of the financial institution to request it to raise necessary cash. The person in charge of the financial institution also transmits the replenishing operation instruction document to the security company to request it to deliver (replenish) the cash to the ATM 10 or collect surplus funds from the ATM 10.

The cash raising division deposits a designated amount of funds in an account for loading funds at designated time according to the cash replenishing instruction document. The security company withdraws a designated amount of cash from the account for loading at designated time, and delivers (replenishes) it to the ATM 10 or collects a designated amount of surplus funds from the ATM 10 according to the cash replenishment instruction document.

The evaluating unit 9 evaluates the realizability of the operation plan (replenishing operation days or the amount/quantity of the replenishment) on the ATM 10 determined by the plan making unit 3. For example, the evaluating unit 9 determines whether or not the number of bills to be replenished planned by the plan making unit 3 exceeds the number of bills that the ATM 10 can accommodate, thereby evaluating the realizability of the operation plan.

As to a result of re-calculation of the operation plan made by the changing unit 8 with a change in the operation plan, the evaluating unit 9 also evaluates whether or not lack of the funds or overflow of the funds occurs in the ATM 10 due to the change.

When the evaluating unit 9 determines that the realizability of the operation plan is small as a result of the evaluation of the replenishing operation, that is, when the number of bills to be replenished planned by the plan making unit 3 exceeds the number of bills that the ATM 10 can accommodate and cannot be accommodated (stored) in the ATM 10, for example, the warning unit 11, gives a warning to the operator. As the warning, a message or the like may be displayed on the display 22, or an alarm may be generated from a speaker or the like not shown. This may be modified in various ways without departing from the scope of this invention.

When the changing unit 8 changes an operation plan made by the plan making unit 3 and the evaluating unit 9 determines on the basis of re-calculation of the operation plan that there is possibility that lack of funds or overflow of the funds occurs in the ATM 10 due to the change, the warning unit 11, notifies the operator of it (for example, “The funds will run out. Will you move it?” or anything).

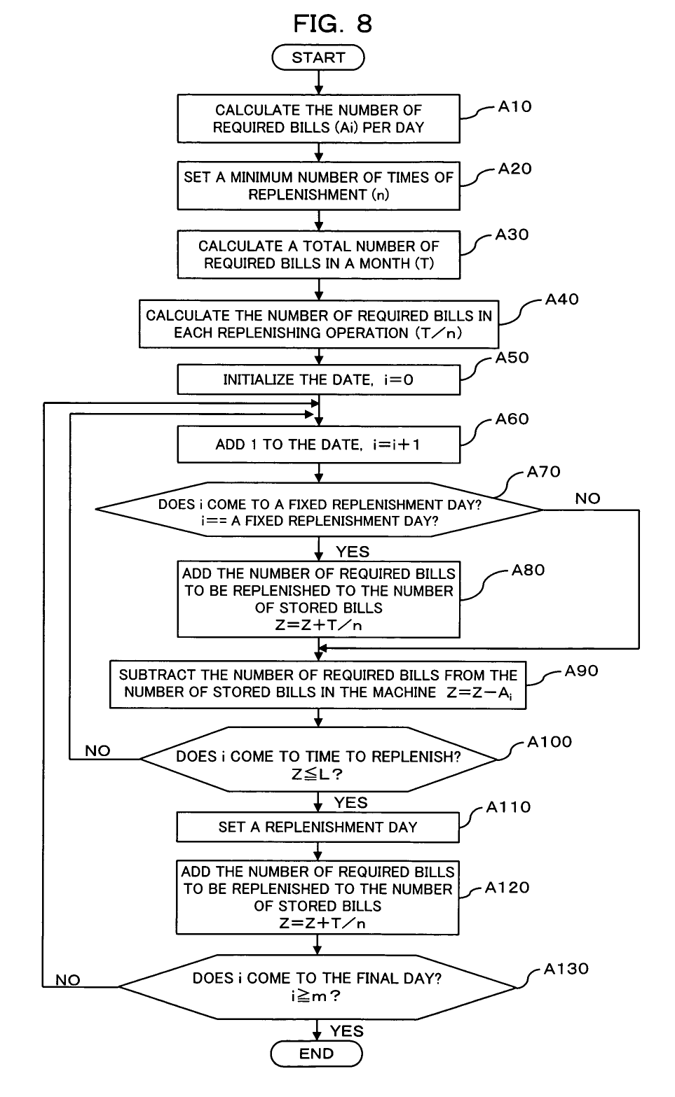

Next, description will be made of a replenishment plan making method in the operation plan devising system 1a according to the first embodiment of this invention structured as above, with reference to a flowchart (steps A10 to A130) shown in FIG. 8. The method shown in FIG. 8 will be described by way of example where an operator sets at least a minimum number of times of replenishment (n) and designates (inputs) a fixed replenishment day at need to make an operation plan on a certain ATM 10 for one month.

Hereinafter, Zi indicates the number of stored bills in an ATM on i day, and L is a reference for determining whether replenishment of bills in the ATM 10 is necessary or unnecessary, indicating a minimum number (for example, L=0) of bills.

The demand estimating unit 2 estimates a necessary number (Ai) of bills (replenishment) for one day at the ATM 10 (step A10). The operator inputs a minimum number of times of replenishment (n) in the input screen 22a displayed on the display 22 (step A20), and inputs a fixed replenishment day at need.

The demand estimating unit 2 totalizes the number of demanded bills (replenishment) of every day (Ai) in a specific period of time (one month in this example) to calculate a total number (T) of demanded bills in the specific period of time (step A30).

The plan making unit 3 calculates the number of necessary bills (the number of bills to be replenished; T/n) in one time of the replenishment on the basis of the minimum number of times of replenishment (n) inputted at step A20 and the total number of demanded bills (T) calculated at step A30 (step A40). The operator sets “i=0” to reset (step A50), then adds “1” to “i” (i=i+1) (step A60).

The plan making unit 3 determines whether or not i agrees with the fixed replenishment day (step A70). When i is the fixed replenishment day (refer to YES route at step A70), the plan making unit 3 adds the number of bills to be replenished (T/n) to a current number of stored bills (Zi) in the ATM 10 (step A80), and reduces the number of demanded bills (Ai) in a day (i) from the current number of stored bills (Zi) (Zi=Zi-Ai) (step A90).

When i is not the fixed replenishment day (refer to NO route at step A70), the procedure proceeds to step A90.

The plan making unit 3 determines whether or not Zi is not larger than L, for example, to determine whether or not i is the replenishment time (step A100). When i is not the replenishment time, that is, when Zi is larger than L (refer to NO route at step A100) step A70 to A100 are repeated.

When i is the replenishment time, that is, when Zi is not larger than L (refer to YES route at step A100), the plan making unit 3 sets i as the replenishment day (step A110), and adds a current number of stored bills in the ATM 10 to the number of bills to be replenished (T/n) (step A120). The plan making unit 3 determines whether or not i is not less than m, for example, to determine whether or not i is the last day of the month, that is, when i is smaller than m (step A130). When i is not the last day of the month (refer to NO route at step A130), steps A60 to A130 are repeated. When i is the last day, that is, when i is not less than m (refer to YES route at step A130), the process is terminated.

In the method described above with reference to the flowchart shown in FIG. 8, it is alternatively possible to determine whether or not the number of times of replenishment is the minimum number of times of replenishment (n). This method may be modified in various ways without departing from the scope of this invention.

The plan making unit 3 carries out the above process to obtain replenishment days at step A110.

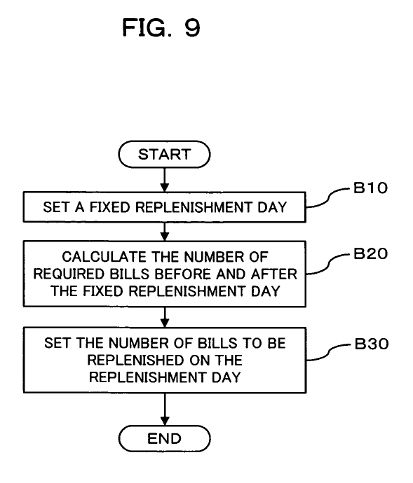

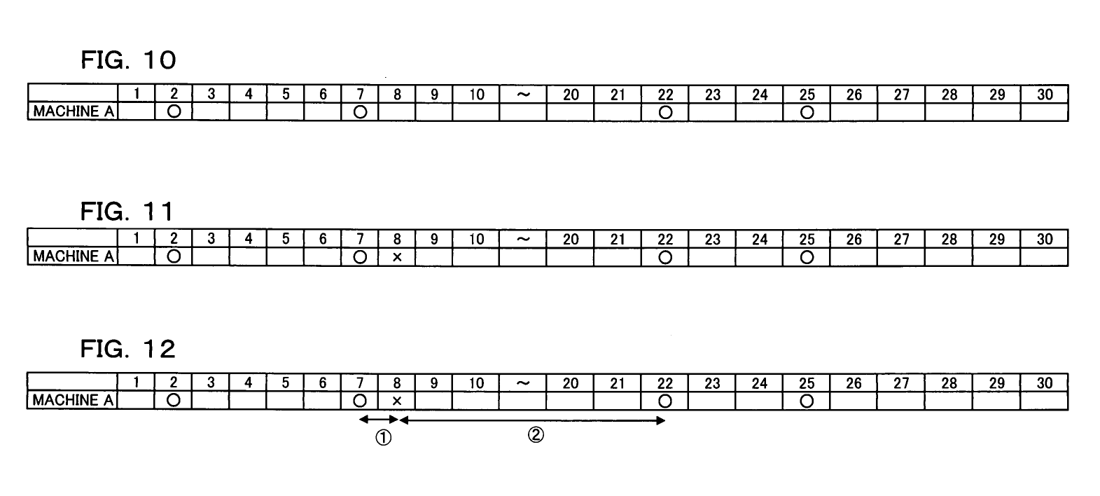

Next, description will be made of another replenishment plan making method in the operation plan devising system 1a according to the first embodiment of this invention with reference to FIGS. 10 through 12 in accordance with a flowchart (steps B10 to B30) shown in FIG. 9. FIGS. 10 through 12 are diagrams showing an example of the operation plan made by the operation plan devising system 1a according to the first embodiment of this invention, where a day marked with “◯” is the replenishing operation day, and a day marked with “X” is the fixed replenishment day. FIGS. 9 through 12 show an example where the operator makes (changes) an operation plan for one month on a certain ATM 10. Here, the operator desires to further add the replenishing operation on “the 8th” as the fixed replenishment day in the operation plan having been already made in which the replenishing operation is to be carried out on the 2nd, 7th, 22nd and 25th using a certain manner.

When the operation plan is that the replenishing operation is to be carried out on “the 2nd, 7th, 22nd and 25th” in a certain manner as shown in FIG. 10, the operator sets the fixed replenishment day (“the 8th” in the example shown in FIG. 11) as shown in FIG. 11 (step B10).

On the basis of the set fixed replenishment day (“the 8th”) as a reference, the plan making unit 3 obtains, from the demand estimating unit 2, demand estimation for a period of time (refer to a period \mathring{1} in FIG. 12) from the fixed replenishment day to a replenishing operation day immediately before the fixed replenishment day (“the 7th” in the example shown in FIG. 11), and demand estimation for a period of time (refer to \mathring{2} in FIG. 12) from the fixed replenishment day to a replenishing operation day immediately after the fixed replenishment day (“the 22nd”), totalizes estimated demands of the days in the periods of time, and calculates the total of estimated numbers of demanded bills (a required number of bills) in the periods of time (step B20).

The plan making unit 3 sets a required number of bills within a period of time from the fixed replenishment day to the replenishing operation day immediately before the fixed replenishment day (“the 7th”) as the number of bills to be replenished on the replenishing operation day immediately before the fixed replenishment day. Similarly, the plan making unit 3 sets a required number of bills within a period of time from the fixed replenishment day to the replenishing operation day (“the 22nd”) immediately after the fixed replenishment day as a required number of bills to be replenished on the replenishing operation day immediately after the fixed replenishment day (step B30), and terminates the process.

The operation plan devising system 1a according to the first embodiment of this invention can set a minimum number of times of replenishment (n) according to operator's (a person in charge or the like of the financial institution) convenience, and readily make an operation plan to replenish bills (replenishment) the minimum number of times (n) within a predetermined period of time (m days). When an operator of the security company is dispatched to do the replenishing operation, the financial institution can request the operator to do an operation other than funds replenishment such as a process of replenishing consumables (for example, receipt forms, journal forms, etc.), resolving a fault or anything as a supplementary operation, which improves the convenience. Further, the operator of the security company can report information on an actual number of stored bills in the ATM 10 more frequently, which improves the estimation accuracy of the demand for funds at the ATM 10.

Moreover, it is possible to arbitrarily set the replenishment day (fixed replenishment day) according to operator's (a person in charge or the like of the financial institution) convenience, which improves the convenience.

Since the evaluating unit 9 evaluates the realizability of an operation plan (replenishing operation days or the number/amount of replenishments) on the ATM 10 determined by the plan making unit 3, it is possible to certainly accomplish the replenishing operation, which improves the reliability of the system.

When the evaluating unit 9 determines, as a result of evaluation of the replenishing operation, that the realizability of the operation plan is small, that is, when the number of bills to be replenished planned by the plan making unit 3 exceeds the number of bills that the ATM 10 can accommodate, thus the ATM 10 cannot accommodate (store) the planned bills therein, for example, the warning unit 9 generates a warning to the operator. Accordingly, the operator can easily and quickly know that the replenishing operation having a low realizability is set, which improves the reliability of the system and the operation plan.

It is possible to arbitrarily set (change) the number of times of replenishment of bills for each ATM 10, which improves the convenience. Particularly, it is possible to set the number of times of replenishment of bills to a large number, whereby more information on an actual number of stored bills in the ATM 10 can be obtained. This is helpful to reduce the danger of stoppage of the ATM 10 due to lack of the funds, for example.

The evaluating unit 9 evaluates a result of re-calculation of the operation plan done with a change in the operation plan by the changing unit 8, and determines whether or not lack of funds or overflow of the funds occurs in the ATM 10 due to the change. When there is possibility that lack of the funds or overflow of the funds occurs, the warning unit 11, generates a warning to the operator, whereby the operator can beforehand avoid the operation plan where lack of the funds or overflow of the funds occurs in the ATM 10. This improves the reliability of the operation plan.

It is possible to readily move or add a replenishment day, which improves the convenience and the estimation accuracy.

When the operation plan is changed by the changing unit 8, the plan making unit 3 again determines at least either the replenishing operation days or the quantity/amount of replenishment on the basis of the changed plan. This enables the operator to readily change the operation plan, which is convenient to the operator.

The changing unit 8 changes the operation plan on the basis of information inputted in a change screen (refer to FIGS. 6 and 7) through which the operation plan displayed on the display 22 can be changed, whereby the operator can readily change the operation plan. This is convenient to the operator.

### (B) Description of Second Embodiment

An operation plan devising system according to a second embodiment of this invention can make a replenishing operation plan, by which the replenishing operation days for a plurality of ATMs 10 are harmonized, the ATMs being installed in the same place or places in proximity to each other such as service offices.

FIG. 13 is a block diagram showing a structure of the operation plan devising system according to the second embodiment of this invention.

The operation plan devising system 1b according to the second embodiment of this invention devises a plan for one or more times of replenishing operation of replenishing cash or other articles by an operator in ATMs (Automated Teller Machines: automatic teller machines, cash automatic transaction apparatuses) each of which accommodates a predetermined amount/quantity of cash and other articles and needs to be replenished with the cash or the other articles, like the operation plan devising system 1a according to the first embodiment. The operation plan devising system 1b is provided to a financial institution such as a bank, a credit loan firm or the like. The operation plan devising system 1a is operated by a person in charge (an operator) of the financial institution, for example, to output (present) an operation plan (a replenishing operation instruction document) to the operator.

Hereinafter, description will be made by way of example where cash and other articles accommodated in the ATM 10 are bills, like the first embodiment.

The operation plan devising system 1b according to the second embodiment has an operation plan devising unit 5b in lieu of the operation plan devising unit 5a in the first embodiment, other units being similar to those of the operation plan devising system 1a in the first embodiment, as shown in FIG. 13.

The operation plan devising unit 5 b comprises, as shown in FIG. 13, a demand estimating unit 2, a demand estimation database 21, a replenishment day estimating unit 12, a plan compensating unit 13b, an outputting unit 4, an inputting unit 7, a changing unit 8, an evaluating unit 9 and a warning unit 11. Incidentally, like reference characters designate like or corresponding parts in the drawings, detailed descriptions of which are thus omitted.

The operation plan devising unit 5b is realized by a computer communicably connected to the ATM 10 as shown in FIG. 2, like the operation plan devising unit 5a in the first embodiment.

The replenishment day estimating unit 12 can estimate a day on which a plurality of ATMs 10 are replenished with the replenishments (cash and other articles), as an operation plan. In concrete, the replenishment day estimating unit 12 calculates and estimates a day (replenishment necessary day) on which bills accommodated in each ATM 10 are required to be replenished (collected) on the basis of a result the demand estimation by the demand estimating unit 2.

The plan compensating unit 13b regards replenishment days of an ATM 10 which needs to be replenished most frequently as reference replenishment days among replenishment days of the other ATMs 10 estimated by the replenishment day estimating unit 12, adjusts the replenishment days of the other ATMs 10 to the reference replenishment days, and compensates the operation plan.

In the operation plan devising system 1b according to the second embodiment, it is possible to set a minimum number of times of replenishment of bills (a designated number of times of replenishment) to each ATM 10. The plan compensating unit 13b adds a replenishment day to an ATM 10 to which the minimum number of times of replenishment is set. When a replenishment day is added, it is desirable to preferentially set a replenishment day to any one of replenishment days of an ATM 10 which needs to be replenished most frequently.

In the operation plan devising system 1b according to the second embodiment, the inputting unit 7 is used by the operator to input conditions (operation conditions) for making an operation plan. The operator inputs a specific replenishing operation day at need.

The outputting unit 4 outputs an operation plan (a replenishing operation instruction document) made (compensated) by the plan compensating unit 13b to present it to the operator. The changing unit 8 can change the operation plan made (compensated) by the plan compensating unit 13b. The evaluating unit 9 evaluates the realizability of the operation plan (replenishing operation days or the number/quantity of replenishments) made (compensated) by the plan compensating unit 13b for each ATM 10. The warning unit 11, generates a warning to the operator when the evaluating unit 9 determines as a result of evaluation that the realizability of the plan is small.

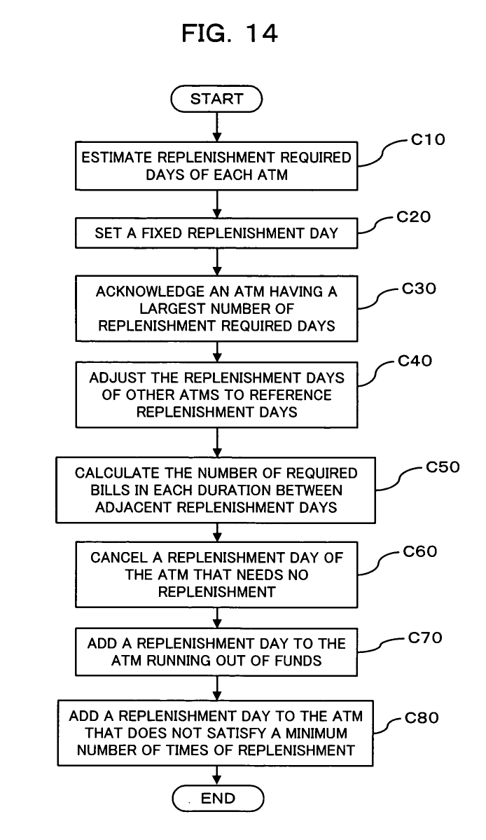

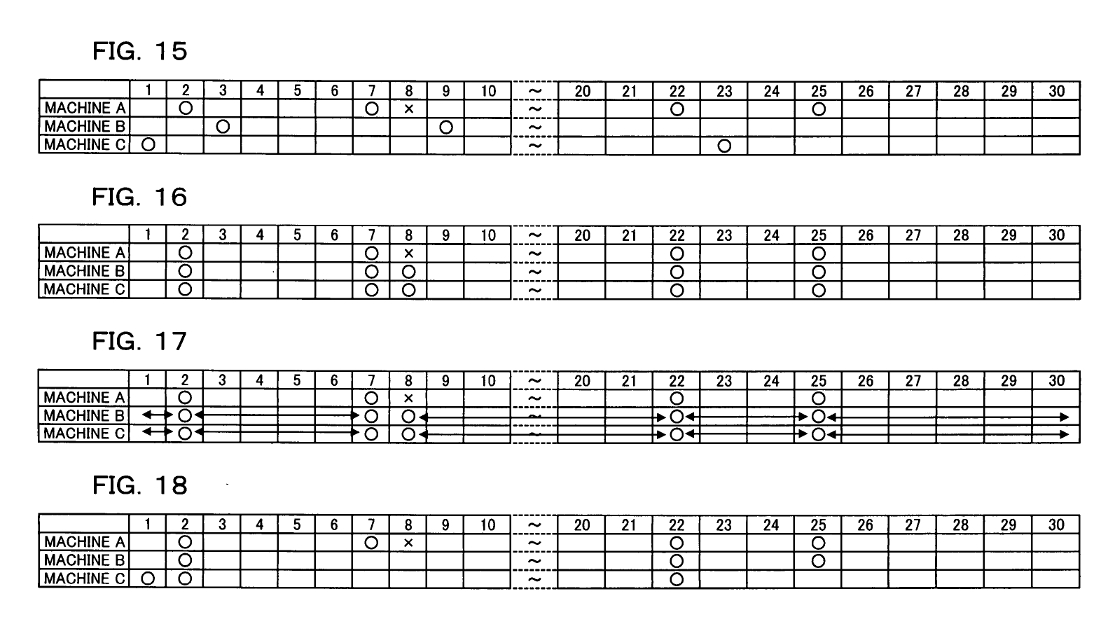

Next, description will be made of a replenishment plan making method in the operation plan devising system 1b according to the second embodiment of this invention with reference to FIGS. 15 through 18 in accordance with a flowchart (steps C10 to C80) in FIG. 14.

FIGS. 15 through 18 are diagrams showing an example of the operation plan made by the operation plan devising system 1b according to the second embodiment of this invention. In FIGS. 15 through 18, a day marked with “◯” is a replenishing operation day, and a day marked with “X” is a fixed replenishment day. The example in FIGS. 15 through 18 shows an operation plan for one month with respect to a plurality of ATMs 10 (in the second embodiment, three apparatuses: A, B and C), in which the operator designates (inputs) a fixed replenishment day.

The replenishment day estimating unit 12 estimates bill replenishment necessary days (fixed replenishment days) of each ATM 10 on the basis of demand estimation at each ATM 10 by the demand estimating unit 2 (step C10; refer to “◯” in FIG. 15). The operator sets a fixed replenishment day through the inputting unit 7 (step C20; refer to “X” in FIG. 15).

The plan compensating unit 13 b selects an ATM 10 (apparatus A in the example shown in FIG. 15) having the largest number of replenishment necessary days among the plural ATMs 10 (step C30). The plan compensating unit 13 b regards the replenishment necessary days (replenishment days; the 2nd, 7th, 8th, 22nd and 25th in the example shown in FIG. 15) of the ATM 10 (machine A in the example shown in FIG. 15) as reference replenishment days, and adjusts replenishment days of the other ATMs 10 (machines B and C) to the reference replenishment days (step C40; refer to FIG. 16). Namely, the plan compensating unit 13b sets the replenishment days so that the other ATMs 10 are replenished on the reference replenishment days.

The plan compensating unit 13b obtains, from the demand estimating unit 2, an estimated demand of each day in each period of time between the replenishment day set at the step C40 (the 2nd, 7th, 8th, 22nd and 25th) and a replenishment day immediately before/after the set replenishment day of each of the other ATMs 10 than the ATM 10 having the largest number of replenishment days, and totalizes estimated demands of the days in each period of time, thereby calculating a total number of demanded bills estimated for each period of time (a necessary number of bills) (step C50; refer to FIG. 17).

The plan compensating unit 13b cancels unnecessary replenishment days on the basis of the number of demanded bills and an estimated number of stored bills calculated at step C50 in each of the machines B and C (step C60; refer to FIG. 18), and adds and sets a replenishment day to the preceding day of a day on which the funds are estimated to run out with respect to an ATM at which the funds are estimated to run out (step C70; refer to FIG. 18).

When the minimum number of times of replenishment is set (inputted) to the ATMs 10, the plan compensating unit 13b adds a replenishment day to a machine which does not satisfy the minimum replenishment days (step C80), and terminates the process.

The operation plan devising system 1b according to the second embodiment of this invention can adjust bill replenishment days of a plurality of ATMs 10, thereby decreasing the number of times of dispatch of the operator(s) or the like of the security company for the replenishing operation. Accordingly, the financial institution can reduce the cost to be paid to the security company, and thus reduce the operation cost.

### (C) Description of Third Embodiment

An operation plan devising system according to a third embodiment of this invention can make a replenishing operation plan for a plurality of ATMs 10 installed in the same place or places in proximity to each other such as service offices, and can adjust replenishing operation days of the plural ATMs 10.

The operation plan devising system 1c according to the third embodiment of this invention devises a plan of one or more times of replenishing operation of replenishing cash and other articles by an operator in a plurality of ATMs (Automated Teller Machines: automatic teller machines, cash automatic transaction apparatuses), each of which accommodates the cash and other articles and needs to be replenished with the cash and other articles, like the operation plan devising system 1b according to the second embodiment. The operation plan devising system 1c is provided to a financial institution such as a bank, a credit loan firm or the like. The operation plan devising system 1c is operated by, for example, a person in charge (an operator) of the financial institution, and outputs (presents) an operation plan (a replenishing operation instruction document) to the operator.

The third embodiment will be described by way of example where bills are used as cash and other articles to be accommodated in the ATM 10, like the first embodiment.

The operation plan devising system 1c according to the third embodiment comprises an operation plan devising unit 5c in lieu of the operation plan devising unit 5b in the second embodiment as shown in FIG. 13, and other units are similar to those of the operation plan devising system 1b in the second embodiment.

The operation plan devising unit 5c comprises a plan compensating unit 13c in lieu of the plan compensating unit 13b as shown in FIG. 13, and other units similar to those of the operation plan devising unit 5b in the second embodiment. Incidentally, like reference characters designate like or corresponding parts in the drawings, details descriptions of which are thus omitted.

The operation plan devising unit 5c is realized by a computer communicably connected to the ATM 10 as shown in FIG. 2, like the operation plan devising unit 5a in the first embodiment.

The plan compensating unit 13c sets, as a reference ATM, an ATM 10 that needs to be replenished first among a plurality of ATMs 10 estimated by the replenishment day estimating unit 12 on the basis of the next replenishment days of the ATMs 10, and sets a replenishment day of the reference ATM as a basic replenishment day. When an ATM 10 having the earliest replenishment necessary day among a plurality of ATMs 10 is the reference ATM 10, the plan compensating unit 13c makes an operation plan so as to adjust replenishment days of the other ATMs 10 to the basic replenishment day.

In the operation plan devising system 1c according to the third embodiment, it is possible to set the number of times that the bill replenishing operation is carried out (a minimum number of times of replenishment) to each ATM 10. When the minimum number of times of replenishment is set, the plan compensating unit 13c adds (a) replenishment day(s) to an ATM 10 that does not satisfy the minimum number of times of replenishment.

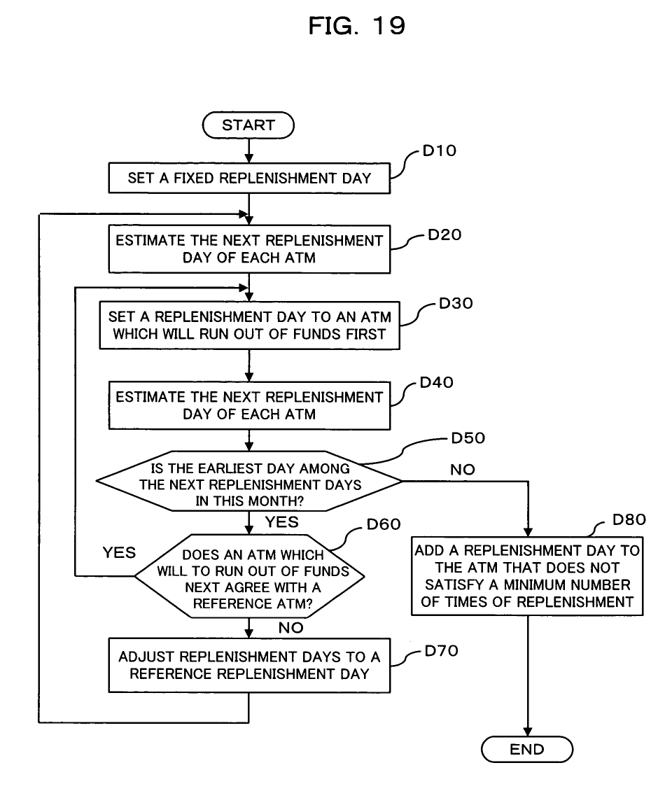

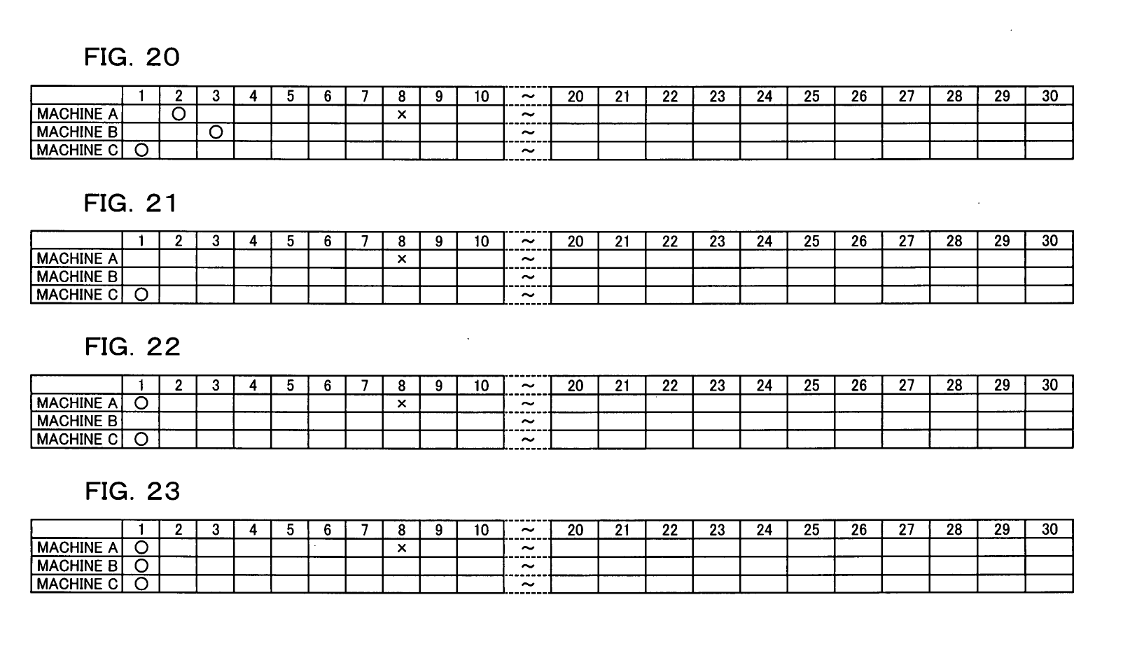

Next, description will be made of a replenishment plan making method in the operation plan devising system 1c structured as above according to the third embodiment of this invention with reference to FIGS. 20 through 23 in accordance with a flowchart (steps D10 to D80) in FIG. 19.

FIGS. 20 through 23 are diagrams showing an example of the operation plan made by the operation plan devising system 1c according to the third embodiment of this invention. In FIGS. 20 through 23, a day marked with “◯” is a replenishing operation day, whereas a day marked with “X” is a fixed replenishment day. The example shown in FIGS. 20 through 23 is an operation plan for one month for a plurality (three: machines A, B and C in the second embodiment) of ATMs 10, and is described by way of example in which the operator designates (inputs) a fixed replenishment day.

The operator sets a fixed replenishment day through the inputting unit 7 (step D10; refer to “X” in FIG. 20). The replenishment day estimating unit 12 estimates the next (earliest) bill replenishment necessary day or a fixed replenishment day of each ATM 10 (step D20; refer to “◯” in FIG. 20). In the example shown in FIG. 20, the earliest replenishment necessary day of the machine A is the 2 nd, the earliest replenishment necessary day of the machine B is the 3rd, and the earliest replenishment necessary day of the machine C is the 1st.

The plan compensating unit 13c sets an ATM 10 having the earliest replenishment day among these ATMs 10 (machines A, B and C), that is, an ATM 10 that needs to be replenished first (machine C in FIG. 20) as a reference ATM, and sets the replenishment day (the 1st in FIG. 20) of the reference ATM as a reference replenishment day (step D30; refer to FIG. 21). The plan compensating unit 13c adds the number of bills of funds to be replenished to the number of stored bills in the reference ATM.

The replenishment day estimating unit 12 estimates the next (earliest) bill replenishment necessary day or a fixed replenishment day on the basis of demand estimation at each ATM 10 by the demand estimating unit 2 and the amount of stored bills at that time in each ATM 10 (step D40).

The replenishment day estimating unit 12 determines, from a result of estimation of the replenishment necessary day obtained at step D40, whether or not the estimated earliest replenishment necessary day is in this month (step D50). When the earliest replenishment necessary day is in this month (refer to YES route at step D50), the replenishment estimating unit 12 determines whether or not an ATM having the earliest replenishment necessary day (machine A in FIG. 22) is the reference ATM (machine C in FIG. 22) set at step D30 (step D60).

When -the ATM 10 having the earliest replenishment necessary day coincides with the reference ATM (refer to YES route at step D60), the procedure proceeds to step D30. The replenishment day estimating unit 12 then sets the earliest replenishment necessary day as the reference replenishment day (refer to FIG. 23), and adds the number of bills of funds to be replenished to the number of stored bills in the reference ATM. When the ATM 10 having the earliest replenishment necessary day does not coincide with the reference ATM (refer to NO route at step D60), the replenishment day estimating unit 12 sets a replenishment day to the reference replenishment day (the 1st in FIG. 22) set at step D30 so that the ATM 10 having the earliest replenishment necessary day is replenished (step D70), and the procedure proceeds to step D20.

When the earliest replenishment necessary day is in the next month as a result of estimation of the replenishment necessary day at step D40 (refer to NO route at step D50), and when the minimum number of times of replenishment is set (inputted) to the ATMs 10, the plan compensating unit 13c adds (a) replenishment day(s) to a machine that does not satisfy the minimum number of times of replenishment (step D80), and terminates the process.

According to the flowchart (refer to FIG. 19) described above, date of the estimated earliest replenishment necessary day is confirmed at step D50. When the date is in the next month, the process for a predetermined period of time (one month) is regarded to be ended, and the procedure proceeds to step D80, and the process is terminated. However, this invention is not limited to the above example. For example, a counter or the like for counting days may be used to determine whether or not the process is to be terminated. As this, the above process may be modified in various ways without departing from the scope of the invention.

The operation plan devising system 1c according to the third embodiment of this invention can adjust bill replenishment days of a plurality of ATMs, like the second embodiment. Accordingly, it is possible to decrease the number of times of dispatch of an operator or the like of the security company for the replenishment operation, thus the financial institution can reduce a cost to be paid to the security company, and reduce the operation cost.

### (D) Others

Note that the present invention is not limited to the above examples, but may be modified in various ways without departing from the scope of the invention.

For example, the demand estimating unit 2 estimates the demand for cash at the ATM 10 in each of the embodiments described above, but the present invention is not limited to this example. The demand estimating unit 2 may estimate the demand for consumables such as receipt forms, journal forms, transfer tickets, receipt/payment slips, passbooks to be issued, etc., and the operation plan devising systems 1a, 1b and 1c may be adapted to devise a plan of such consumable replenishing operation.

In which case, the demand estimating unit 2 can estimate the demand for consumables such as receipt forms, journal forms, transfer tickets, receipt/payment slips, passbook to be issued, etc. at each ATM 10 on the basis of past transaction data accumulated in the demand estimation database 21. In concrete, the demand estimating unit 2 collects the quantity of consumption of the consumables on the basis of the amount of transactions (the number of transactions) at the ATM 10, stores the data in the demand estimation database 21 like cash in the above examples, and estimates the demand for the consumables at the ATM 10 on the basis of information stored in the demand estimation database 21.

When a plurality of ATMs 10 are installed in the same store 102 or 103, the demand estimating unit 2 may regard the plural ATMs 10 as one ATM (group management), and estimate a total quantity of the consumables (the quantity of all demanded consumables), like cash (bills).

The method for estimating the demand for replenishment (cash/consumables) by the demand estimating unit 2 is not limited to the method disclosed in Japanese Patent Laid-Open Publication No. 9-27002, but may be modified in various ways without departing from the scope of the invention.

In the first embodiment, the demand estimating unit 2, the demand estimation database 21, the plan making unit 3, the outputting unit 4, the inputting unit 7, the changing unit 8, the evaluating unit 9 and the warning unit 11, are realized by the same computer. However, the present invention is not limited to the above. At least a part of the demand estimating unit 2, the demand estimation database 21, the plan making unit 3, the outputting unit 4, the inputting unit 7, the changing unit 8, the evaluating unit 9 and the warning unit 11, may be realized by another computer communicably connected to the operation plan devising unit 5a. This may be modified in various ways without departing from the scope of the invention.

In the second and third embodiments, the demand estimating unit 2, the demand estimation database 21, the replenishment day estimating unit 12, the plan compensating unit 13b or 13c, the outputting unit 4, the inputting unit 7, the changing unit 8, the evaluating unit 9 and the warning unit 11, are realized by the same computer. However, the present invention is not limited to the above. At least a part of the demand estimating unit 2, the demand estimation database 21, the replenishment day estimating unit 12, the plan compensating unit 13b or 13c, the outputting unit 4, the inputting unit 7, the changing unit 8, the evaluating unit 9 and the warning unit 11, may be realized by another computer communicably connected to the operation plan devising unit 5a.

In the first embodiment, the operator can input at least a minimum number of times of replenishment, and input (designate) a fixed replenishment day at need. However, the present invention is not limited to the above. The operator may input only a fixed replenishment day, or the operator may make an operation plan, without inputting the minimum number of times of replenishment and the fixed replenishment day. When the minimum number of times of replenishment is not inputted, the plan making unit 3 makes an operation plan on the basis of demand estimation made by the demand estimating unit 2 so that the number of times of replenishment is the optimum.

Each of the embodiments described above is mainly a case where bills are replenished in the ATM 10. However, the present invention is not limited to this. When there is possibility that the funds overflow from the ATM 10, the operation plan may be made to collect the bills from the ATM 10 (collecting operation).

Each of the embodiments described above is a case where an operation plan for every day is made. However, the present invention is not limited to this. For example, it is possible to make an operation plan for a unit other than day, such as hour, minute, second, week, month or the like.

What is claimed is:

1. An operation plan devising system devising a plan for at least one time of replenishing operation that at least one operator replenishes cash and other articles in a cash automatic transaction apparatus which accommodates a predetermined amount/quantity of said cash and other articles and needs to be replenished with said cash and other articles, said operation plan devising system comprising:
a demand estimating unit estimating a demand for said cash and other articles per unit time as replenishments in said cash automatic transaction apparatus;
an inputting unit inputting the number of times of said replenishment operation or a specific replenishing operation day within a predetermined period of time on said cash automatic transaction apparatus; and
a plan making unit making an operation plan having replenishing operation days including said specific replenishing operation day and an amount/quantity of said replenishments to be replenished on said replenishing operation days on the basis of a result of demand estimation made by said demand estimating unit and the number of times of said replenishing operation or said specific replenishing operation day inputted through said inputting unit so that said replenishing operation is carried out said number of times within said predetermined period of time and on a specific replenishing operation day.

2. The operation plan devising system according to claim 1 further comprising:
a changing unit being able to change said operation plan made by said plan making unit;
when said operation plan is changed by said changing unit, said plan making unit re-determining at least either said replenishing operation days or said amount/quantity of said replenishments on the basis of said operation plan after changed.

3. The operation plan devising system according to claim 2 further comprising:
a displaying unit being able to display said operation plan made by said plan making unit;
said changing unit changing said operation plan on the basis of information inputted in a changing screen through which said operation plan displayed on said displaying unit can be changed.

4. The operation plan devising system according to claim 1 further comprising:
an evaluating unit evaluating realizability of said operation plan on said cash automatic transaction apparatus determined by said plan making unit; and
a warning unit generating a warning when said evaluating unit determines as a result of evaluation that the realizability of said operation plan is small.

5. The operation plan devising system according to claim 2 further comprising:
an evaluating unit evaluating realizability of said operation plan on said cash automatic transaction apparatus determined by said plan making unit; and
a warning unit generating a warning when said evaluating unit determines as a result of evaluation that the realizability of said operation plan is small.

6. An operation plan devising system devising a plan for at least one time of replenishing operation that at least one operator replenishes cash and other articles in a plurality of cash automatic transaction apparatuses each of which accommodates a predetermined amount/quantity of said cash and other articles and needs to be replenished with said cash and other articles, said operation plan devising system comprising:
a replenishment day estimating unit being able to estimate replenishment required days on which said cash and other articles are to be replenished as replenishments in each of said plural cash automatic transaction apparatuses as an operation plan; and
a plan compensating unit regarding replenishment days of a cash automatic transaction apparatus which needs to be replenished most frequently among said plural cash automatic transaction apparatuses as reference replenishment days on the basis of said replenishment required days of said plural cash automatic transaction apparatuses estimated by said replenishment day estimating unit, and adjusting replenishment days of other cash automatic transaction apparatuses to said reference replenishment days to compensate said operation plan.

7. An operation plan devising system devising a plan for at least one time of replenishing operation that at least one operator replenishes cash and other articles in a plurality of cash automatic transaction apparatuses each of which accommodates a predetermined amount/quantity of said cash and other articles and needs to be replenished with said cash and other articles, said operation plan devising system comprising:
a replenishment day estimating unit estimating the next replenishment required day on which said cash and other articles are to be replenished as replenishments in each of said plural cash automatic transaction apparatuses on the basis of a basic replenishment day as a reference; and
a plan making unit setting a cash automatic transaction apparatus which needs to be replenished earliest among said plural cash automatic transaction apparatuses as a reference cash automatic transaction apparatus on the basis of the next replenishment required days of said plural cash automatic transaction apparatuses estimated by said replenishment day estimating unit, setting a replenishment day of said reference cash automatic transaction apparatus as said basic replenishment day, and when said cash automatic transaction apparatus whose next replenishment required day is the earliest among said plural cash automatic transaction apparatuses is said reference cash automatic transaction apparatus, adjusting replenishment days of other cash automatic transaction apparatuses to said basic replenishment day to make an operation plan.

8. An operation plan devising apparatus devising a plan for at least one time of replenishing operation that at least one operator replenishes cash and other articles in a cash automatic transaction apparatus which accommodates a predetermined amount/quantity of said cash and other articles and needs to be replenished with said cash and other articles, said operation plan devising apparatus comprising:
an inputting unit inputting the number of times of said replenishing operation or a specific replenishing operation day within a predetermined period of time on said cash automatic transaction apparatus; and
a plan making unit determining an operation plan having replenishing operation days including said specific replenishing operation day and an amount/quantity of said replenishments on said replenishing operation day on the basis of a result of demand estimation for said cash and other articles as replenishments per unit time in said cash automatic transaction apparatus and the number of times of said replenishing operation or said specific replenishing operation day inputted through said inputting unit so that said replenishing operation is carried out said number of times within said predetermined period of time and on a specific replenishing operation day.

9. The operation plan devising apparatus according to claim 8 further comprising:
a changing unit being able to change said operation plan made by said plan making unit;
when said operation plan is changed by said changing unit, said plan making unit re-determining at least either said replenishing operation days or said amount/quantity of said replenishments on the basis of said operation plan after changed.

10. The operation plan devising apparatus according to claim 8 further comprising:
an evaluating unit evaluating realizability of said operation plan on said cash automatic transaction apparatus determined by said plan making unit; and
a warning unit generating a warning when said evaluating unit determines as a result of evaluation that the realizability of said operation plan is small.

11. An operation plan devising apparatus devising a plan for at least one time of replenishing operation that at least one operator replenishes cash and other articles in a plurality of cash automatic transaction apparatuses each of which accommodates a predetermined amount/quantity of said cash and other articles and needs to be replenished with said cash and other articles, said operation plan devising apparatus comprising:
a replenishment day estimating unit being able to estimate replenishment required days on which said cash and other articles are to be replenished as replenishments in each of said plural cash automatic transaction apparatuses as an operation plan; and
a plan compensating unit regarding replenishment days of a cash automatic transaction apparatus which needs to be replenished most frequently among said plural cash automatic transaction apparatuses as reference replenishment days on the basis of said replenishment required days of said plural cash automatic transaction apparatuses estimated by said replenishment day estimating unit, and adjusting replenishment days of other cash automatic transaction apparatuses to said reference replenishment days to compensate said operation plan.

12. A computer readable record medium holding an operation plan devising program for making a computer execute an operation plan devising function of devising a plan for at least one time of replenishing operation that at least one operator replenishes cash and other articles in a cash automatic transaction apparatus which accommodates a predetermined amount/quantity of said cash and other articles and needs to be replenished with said cash and other articles, said operation plan devising program making said computer function as:
an inputting unit inputting the number of times of said replenishing operation or a specific replenishing operation day within a predetermined period of time on said cash automatic transaction apparatus; and
a plan making unit determining an operation plan having replenishing operation days including said specific replenishing operation day and an amount/quantity of said replenishments on said replenishing operation day on the basis of a result of demand estimation for said cash and other articles as replenishments per unit time in said cash automatic transaction apparatus and the number of times of said replenishing operation or said specific replenishing operation day inputted through said inputting unit so that said replenishing operation is carried out said number of times within said predetermined period of time and on a specific replenishing operation day.

13. The computer readable record medium holding an operation plan devising program according to claim 12, wherein said operation plan devising program makes said computer function as:
a changing unit being able to change said operation plan made by said plan making unit;
when said operation plan is changed by said changing unit, said plan making unit re-determining at least either said replenishing operation days or said amount/quantity of said replenishments on the basis of said operation plan after changed.

14. The computer readable record medium holding an operation plan devising program according to claim 12, wherein said operation plan devising program makes said computer function as:
an evaluating unit evaluating realizability of said operation plan on said cash automatic transaction apparatus determined by said plan making unit; and
a warning unit generating a warning when said evaluating unit determines as a result of evaluation that the realizability of said operation plan is small.

15. A computer readable record medium holding an operation plan devising program for making a computer execute an operation plan devising function of devising a plan for at least one time of replenishing operation that at least one operator replenishes cash and other articles in a plurality of cash automatic transaction apparatuses each of which accommodates a predetermined amount/quantity of said cash and other articles and needs to be replenished with said cash and other articles, said operation plan devising program making said computer function as:
a replenishment day estimating unit being able to estimate replenishment required days on which said cash and other articles need to be replenished as replenishments in each of said plural cash automatic transaction apparatuses as an operation plan; and
a plan compensating unit regarding replenishment days of a cash automatic transaction apparatus which needs to be replenished most frequently among said plural cash automatic transaction apparatuses as reference replenishment days on the basis of said replenishment required days of said plural cash automatic transaction apparatuses estimated by said replenishment day estimating unit, and adjusting replenishment days of other cash automatic transaction apparatuses to said reference replenishment days to compensate said operation plan.

16. A computer readable record medium holding an operation plan devising program for making a computer execute an operation plan devising function of devising a plan for at least one time of replenishing operation that at least one operator replenishes cash and other articles in a plurality of cash automatic transaction apparatuses each of which accommodates a predetermined amount/quantity of said cash and other articles and needs to be replenished with said cash and other articles, said operation plan devising program making said computer function as:
a replenishment day estimating unit estimating the next replenishment required day on which said cash and other articles are to be replenished as replenishments in each of said plural cash automatic transaction apparatuses on the basis of a basic replenishment day as a reference; and
a plan making unit setting a cash automatic transaction apparatus which needs to be replenished earliest among said plural cash automatic transaction apparatuses as a reference cash automatic transaction apparatus on the basis of the next replenishment required days of said plural cash automatic transaction apparatuses estimated by said replenishment day estimating unit, setting a replenishment day of said reference cash automatic transaction apparatus as said basic replenishment day, and when said cash automatic transaction apparatus whose next replenishment required day is the earliest among said plural cash automatic transaction apparatuses is said reference cash automatic transaction apparatus, adjusting replenishment days of other cash automatic transaction apparatuses to said basic replenishment day to make an operation plan.
